(19) United States
(12) Patent Application Publication
(10) Pub. No.: US 2009/0051097 A1
(43) Pub. Date: Feb. 26, 2009

(54) QUICKLY ASSEMBLED AND DISASSEMBLED NON-RETURN PLATE FOR A TABLE SAWING MACHINE

(76) Inventor: Bor-Yann Chuang, Taiping City (TW)

Correspondence Address: SINORICA, LLC, 528 FALLSGROVE DRIVE, ROCKVILLE, MD, 20850, US

(21) Appl. No.: 11/842,949

(22) Filed: Aug. 22, 2007

(51) Int. Cl. B23Q 3/00

(52) U.S. Cl. 269/318

(57) ABSTRACT

A quickly assembled and disassembled non-return plate for a table sawing machine is assembled on an assembly base of a quickly disassembling device to be pivotally engaged in a pivot notch of a chopper plate by a position-limiting rotary shaft acting as a pivot. A positioning pin is to be axially positioned in a positioning hole of the assembly base. When operated to shift axially, the positioning pin can be inserted and positioned in or disengaged from a through hole of the chopper plate and fixed in position by a positioning member. By so designing, the assembly base can be quickly engaged on or disengaged from the chopper, able to achieve an objective of quick assembling and disassembling of the non-return plates.

### BACKGROUND OF THE INVENTION

1. Field of the Invention

This invention relates to a non-return plate of a table sawing machine, particularly to one able to be quickly assembled on or disassembled from a chopper plate.

2. Description of the Prior Art

A conventional non-return plate unit 10 is disposed thereon with a quick disassembly device 20 assembled on a chopper plate 11. The quick disassembly device 20 is composed of an assembly base 21, two nuts 22, a shaft pin 23, a spring 24 and a press member 25. The assembly base 21 is bored with an insert slot 211 for receiving a combining end 111 of the chopper plate 11, having its outer edge resisting on an edge of the chopper plate 11. The shaft pin 23 is engaged in a pin hole 112 of the chopper plate 11, and the press member 25 can be pressed to push the shaft pin 23 to move away from the pin hole 112 of the chopper plate 11, enabling the assembly base 21 and two non-return plates 12 to disengage from the chopper plate 11. However, the quick disassembly device 20 has too many components and is complicated in assembling, and the extent of relative displacement between the shaft pin 24 and the press member 25 must be extremely accurate to match with an end center of the chopper plate 11, rendering the shaft pin 24 difficult to be smoothly engaged in or disengaged from the pin hole 112 of the chopper plate 11 and disabling the two non-return plates 12 to be quickly assembled on or disassembled from the chopper plate 11.

### SUMMARY OF THE INVENTION

The objective of this invention is to offer a quickly assembled and disassembled non-return plate for a table sawing machine, which is assembled on an assembly base of a quick disassembly device. The quick disassembly device is provided with a position-limiting rotary shaft pivotally engaged in a pivot notch of a chopper plate to act as a pivot, and a positioning pin axially positioned in a positioning hole of the assembly base. When operated to shift axially, the positioning pin can be inserted and positioned in or moved away from a through hole of the chopper plate, with a positioning member securing the positioning pin in position. By so designing, the assembly base can be quickly engaged on or disengaged from the chopper plate, achieving an objective of quickly assembling and disassembling of the non-return plates.

### BRIEF DESCRIPTION OF DRAWINGS

This invention will be better understood by referring to the accompanying drawings, wherein:

FIG. 1 is a cross-sectional view of a quickly disassembling device of a conventional non-return plate;

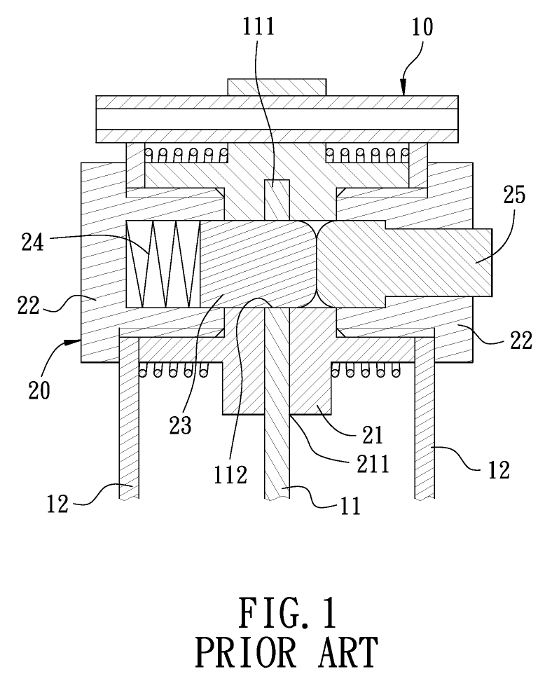

FIG. 2 is a partial exploded perspective view of a first preferred embodiment of a quickly assembled and disassembled non-return plate for a table sawing machine in the present invention;

FIG. 3 is a cross-sectional view of the first preferred embodiment of the quickly assembled and disassembled non-return plate for a table sawing machine in the present invention;

FIG. 4 is a side cross-sectional view of the first preferred embodiment of a position-limiting rotary shaft in an engaging and rotating condition in the present invention;

FIG. 5 is a cross-sectional view of the first preferred embodiment of the quickly assembled and disassembled non-return plate for a table sawing machine in an assembled condition in the present invention; and

FIG. 6 is a cross-sectional view of a second preferred embodiment of a quickly assembled and disassembled non-return plate for a table sawing machine in the present invention.

### DETAILED DESCRIPTION OF THE PREFERRED EMBODIMENT

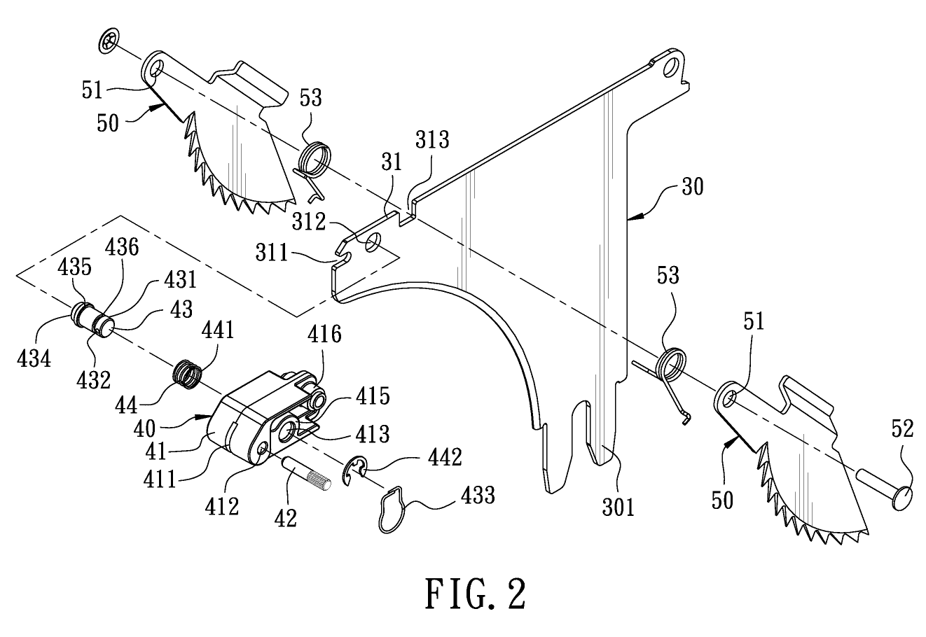

A first preferred embodiment of a quickly assembled and disassembled non-return plate for a table sawing machine in the present invention, as shown in FIGS. 2, 3 and 4, includes a chopper plate 30, a quickly disassembling device 40 and two non-return plates 50 as main components combined together.

The chopper plate 30 has its lower portion provided with a fixing end 301 to be secured on a machine body of a table sawing machine (not shown) and its upper portion provided with combining end 31 having one side bored with a pivot notch 311 and a through hole 312 at a location adjacent to the pivot notch 311. Further, the combining end 31 is cut with a depositing recess 313 with an upward opening at a location near the through hole 312, with the depositing recess 313 and the through hole 312 positioned in parallel.

The quickly disassembling device 40 is composed of an assembly base 41, a position-limiting rotary shaft 42, a positioning pin 43 and a positioning member 44.

The assembly base 41 has its center bored with an insert slot 411 to be fitted on the combining end 31 of the chopper plate 30 and is axially bored with a shaft hole 412 and a positioning hole 413 respectively corresponding to the pivot notch 311 and the through hole 312 of the chopper plate 30, with the shaft hole 412 and the positioning hole 413 intersected vertically with the insert slot 411. The front side of the positioning hole 413 is comparatively small in diameter, and the inner side and the outer side of the positioning hole 413 are respectively formed with an inner wall edge 414 and an outer wall edge 415. Further, the assembly base 41 is fixed with a hollow pivot 416 at one side opposite to the shaft hole 412.

The position-limiting rotary shaft 42 is fixedly inserted in the shaft hole 412, having a part that passes through the insert slot 411 visibly exposed.

The positioning pin 43 to be inserted in the positioning hole 413 of the assembly base 41 has its front end provided with an operating portion 431 diametrically bored with a hole 432 near its front end for a pull ring 433 to be clasped therein. The positioning pin 43 is further formed with a positioning portion 434 at its rear end and a stop flange 435 abutting the positioning portion 434 and also annularly bored with a positioning groove 436 at a location between the stop flange 435 and the operating portion 431. The operating portion 431 of the positioning pin 43 can be a protuberant grip formed integrally, or a toothed ring having its circumference formed with embossed patterns for facilitating holding and operating.

The positioning member 44 is a spring 441 to be fitted on a circumference between the stop flange 435 and the positioning groove 436 of the positioning pin 43, with a C-shaped clasp 442 clasped around the positioning groove 436. The spring 441 has its opposite ends respectively pushing against the stop flange 435 and the inner wall edge 414 of the positioning hole 413, while the C-shaped clasp 442 resists on the outer wall edge 415 of the positioning hole 413, thus enabling the positioning pin 43 to be actuated to recover its original position by means of the spring 441.

The two non-return plates 50 respectively have one end bored with a pivot hole 51 near its upper edge to be pivotally fitted on the pivot 416 of the assembly base 41 by a bolt 52, letting the two non-return plates 50 respectively positioned at the opposite sides of the chopper plate 30, and two torsional elastic members 53 are respectively disposed between the non-return plate 50 and the chopper plate 30 for elastically pressing the non-return plates 50.

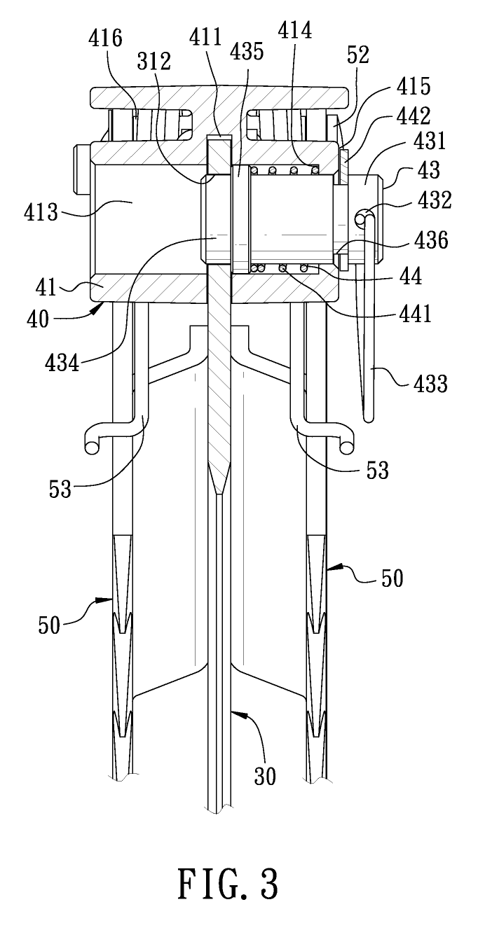

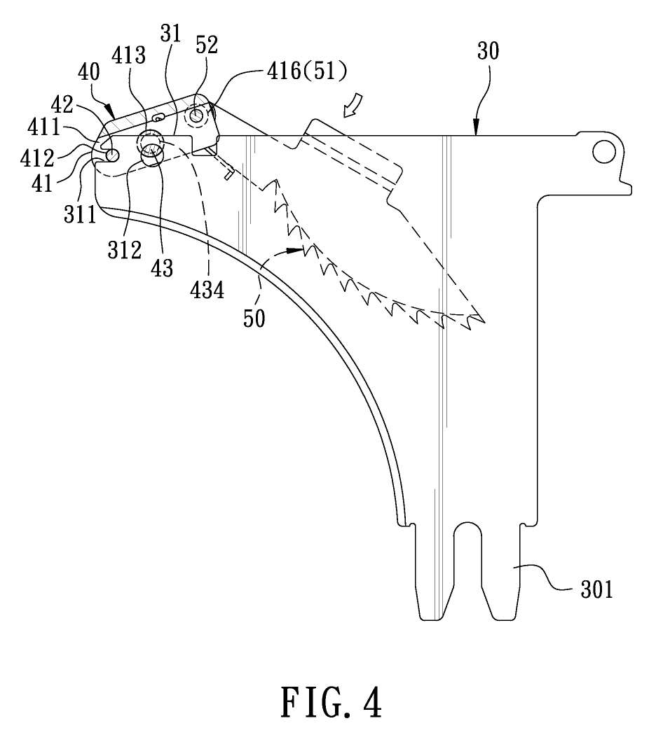

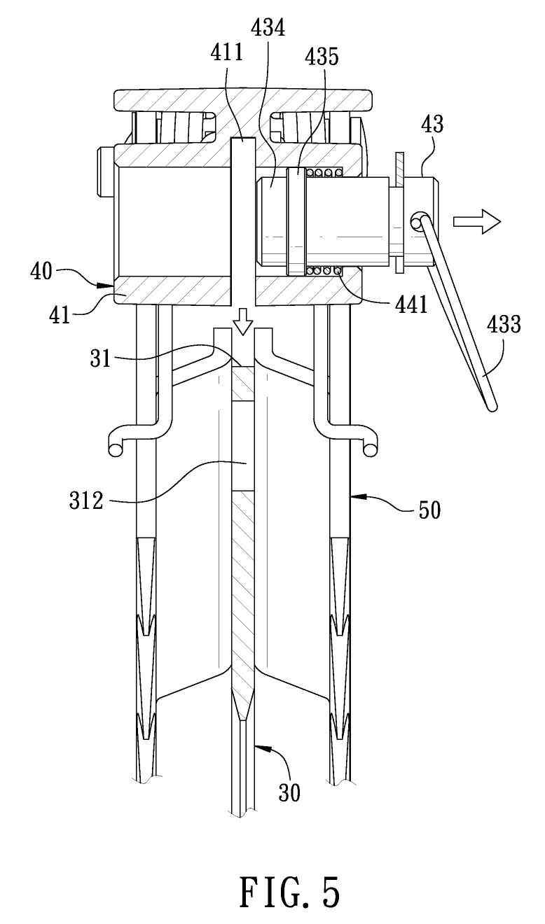

In assembling of the non-return plates 50, as shown in FIGS. 4 and 5, firstly, the position-limiting rotary shaft 42 is aligned to the pivot notch 311 of the chopper plate 30 and pivotally engaged therein and then pull the pull ring 433 to let the positioning pin 43 shift axially toward a front side. Meanwhile, the positioning pin 43, with the position-limiting rotary shaft 42 acting as a pivot, is turned toward combining end 31 of the chopper plate 30 to let the insert slot 411 of the assembly base 41 engaged and fixed on the combining end 31 and let the positioning hole 413 of the assembly base 31 aligned to the through hole 312 of the chopper plate 31. Subsequently, referring to FIG. 3, release the pull ring 433, and the positioning pin 43 will recover its original position by restored elastic force of the spring 441 and have its positioning portion 434 inserted in the through hole 312 of the chopper plate 31 and its stop flange 435 blocked and positioned at the outside of the through hole 312, thus quickly assembling the non-return plates 50 on the chopper plate 30 by means of the positioning pin 43.

On the contrary, to disassemble the non-return plates 50 from the chopper plate 30, simply pull the pull ring 433 again to actuate the positioning pin 43 to shift axially toward a front side and have the positioning portion 434 disengaged from the through hole 312 of the chopper plate 30. Then, the positioning pin 43, with the position-limiting rotary shaft 42 serving as a pivot, is turned reversely from the combining end 31 and moved away from the pivot notch 311 of the chopper plate 30, and thus the assembly base 41 can be disengaged from the chopper plate 30, and the non-return plates 50 can be disassembled from the chopper plate 30.

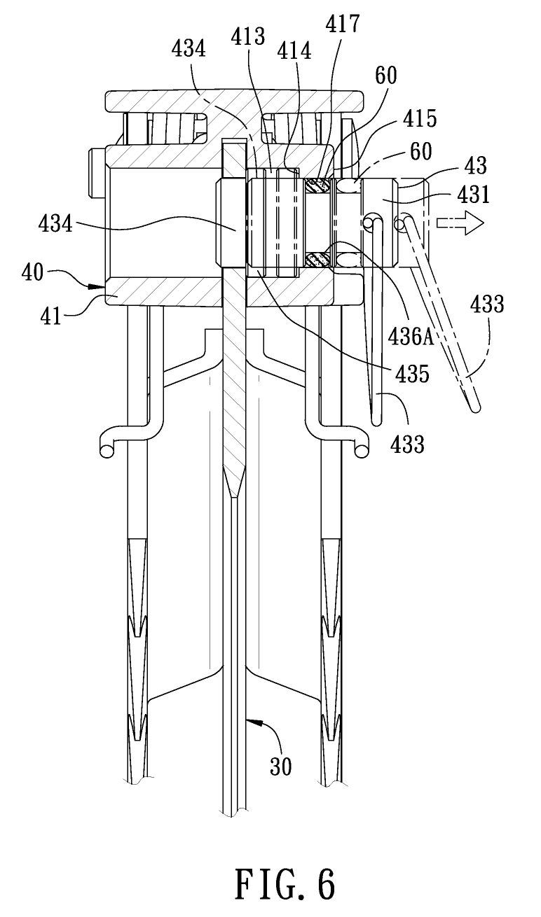

A second preferred embodiment of a quickly assembled and disassembled non-return plate for a table sawing machine in the present invention, as shown in FIG. 6, has almost the same structure as that described in the first preferred embodiment, except that the positioning member is an O-shaped ring 60 to be fitted in an annular positioning groove 436A bored at a location between the stop flange 435 and the operating portion 431 of the positioning pin 43. When the pull ring 433 is pulled to let the positioning pin 43 shifted axially toward a front side, the positioning portion 434 of the positioning pin 43 will be moved away from the through hole 312 of the chopper plate 30 and at this time, the O-shaped ring 60 is positioned at the outside of the outer wall edge 415 of the positioning hole 413, thus able to quickly disengage the assembly base 41 from the chopper plate 30.

On the contrary, when the positioning pin 43 is pushed to move axially, the positioning portion 434 will be inserted in the through hole 312 of the chopper plate 30 and the stop flange 435 will be blocked at the outside of the through hole 312. At this time, the positioning pin 43 can be tightly positioned on a circumference 417 between the inner wall edge 414 and the outer wall edge 415 of the positioning hole 413 of the assembly base 41 by means of the O-shaped ring 60, and thus the assembly base 41 can be quickly engaged and assembled on the chopper plate 30.

Specifically, the quickly assembled and disassembled non-return plate for a table sawing machine in the present invention is provided with the quick disassembly device that is composed of only a few components and simple in operating. The positioning pin of the quick disassembly device can be pushed to quickly engage in the through hole of the chopper plate and fixed in position by the positioning member, or pulled to quickly disengage from the through hole, thus attaining an objective of quickly assembling or disassembling of the non-return plates.

While the preferred embodiments of the invention have been described above, it will be recognized and understood that various modifications may be made therein and the appended claims are intended to cover all such modifications that may fall within the spirit and scope of the invention.

I claim:

1. A quickly assembled and disassembled non-return plate for a table sawing machine comprising:
a chopper plate having one end of its upper portion cut with a pivot notch, said chopper plate bored with a through hole at a location adjacent to said pivot notch;
a quick disassembly device provided with an assembly base operated to be optionally assembled on an upper portion of said chopper plate, said assembly base axially bored with a positioning hole corresponding to said through hole of said chopper plate, said assembly base having its center longitudinally cut with an insert slot intersected vertically with said positioning hole, said quick disassembly device further provided with a position-limiting rotary shaft and a positioning pin, said position-limiting rotary shaft pivotally engaged in said pivot notch of said chopper plate to act as a pivot, said assembly base operated to have said positioning hole matching with two opposite sides of said through hole of said chopper plate, said positioning pin having one end formed with an operating portion and another end formed with a positioning portion, said positioning portion operated to be axially positioned in said positioning hole of said assembly base, and said operating portion extended out of said positioning hole, said positioning pin fitted thereon with a positioning member at a proper location, said positioning portion of said positioning pin inserted in said through hole of said chopper plate and secured therein by said positioning member when said positioning pin is pushed to shift axially, said positioning portion moved away from said through hole to let said assembly base disengaged from said chopper plate when said positioning pin is pulled to shift axially; and
two non-return plates pivotally assembled on said assembly base and respectively positioned at two opposite sides of said chopper plate.

2. The quickly assembled and disassembled non-return plate for a table sawing machine as claimed in claim 1, wherein said positioning portion of said positioning pin is provided with a stop flange at a rear end and said positioning pin is annularly bored with a positioning groove at a location between said stop flange and said operating portion, said positioning member being a spring to be fitted on a circumference between said stop flange and said positioning groove, said spring having its opposite ends respectively pushing against said stop flange and an inner wall edge of said positioning hole of said assembly base, a C-shaped clasp clasped in said positioning groove and resisting on an outer wall edge of said positioning hole, said positioning pin disengaged from said through hole of said chopper plate when said positioning pin is pulled to shift axially, said positioning pin recovering its original position by restored elastic force of said spring to have said positioning portion inserted in said through hole of said chopper plate when said positioning pin is released from pull force.

3. The quickly assembled and disassembled non-return plate for a table sawing machine as claimed in claim 2, wherein said operating portion of said positioning pin is diametrically bored with a hole for a pull ring to be clasped therein.

4. The quickly assembled and disassembled non-return plate for a table sawing machine as claimed in claim 2, wherein said operating portion of said positioning pin is a protuberant grip extended integrally.

5. The quickly assembled and disassembled non-return plate for a table sawing machine as claimed in claim 2, wherein said operating portion of said positioning pin is a toothed ring having its circumference formed with embossed patterns.

6. The quickly assembled and disassembled non-return plate for a table sawing machine as claimed in claim 1, wherein said positioning pin is annularly provided with a positioning groove at a location between said stop flange and said operating portion, and said positioning member is an O-shaped ring, said O-shaped ring fitted in said positioning groove and able to be tightly positioned on or disengaged from a circumference of said positioning hole of said assembly base.

7. The quickly assembled and disassembled non-return plate for a table sawing machine as claimed in claim 6, wherein said operating portion of said positioning pin is bored with a hole for a pull ring to be clasped therein.

8. The quickly assembled and disassembled non-return plate for a table sawing machine as claimed in claim 6, wherein said operating portion of said positioning pin is a bulging grip extended outward integrally.

9. The quickly assembled and disassembled non-return plate for a table sawing machine as claimed in claim 6, wherein said operating portion of said positioning pin is a toothed ring formed with embossed patterns on its circumference.
